(19) United States
(12) Patent Application Publication
(10) Pub. No.: US 2018/0334851 A1
(43) Pub. Date: Nov. 22, 2018

(54) Winter Blind Covering Insulation

(71) Applicant: Jacqueline R. Wilson, Charlotte, NC (US)

(72) Inventor: Jacqueline R. Wilson, Charlotte, NC (US)

(21) Appl. No.: 15/596,976

(22) Filed: May 16, 2017

(51) Int. Cl. E06B 9/38; E06B 3/30

(52) U.S. Cl. CPC E06B 9/38; E06B 3/30

(57) ABSTRACT

A winter insulation covering for installation over a venetian blind. The invention, made of heavy poly plastic sheeting, fits over the blind headrail draping to the bottom of the front and back of the blind. The covering is sewn on both sides except openings at the top of the sides allowing the headrail to fit through for attaching to the box brackets. Seven industrial strips of carpet tape, three on each side and one on the bottom of the covering is used for taping to the casings and sill of the window keeping the venetian blind and covering stable helping in energy conservation. An optional felt, lace or other material sheet can be sewn or fastened to the winter blind covering insulation to appear as drapery or a curtain on the outside of the window.

### CROSS-REFERENCE TO RELATED APPLICATIONS

Not Applicable.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM, LISTING COMPACT DISC APPENDIX

Not Applicable

### BACKGROUND OF THE INVENTION

### 1. Field of the Invention.

This invention relates to the field of venetian blind covering for windows and improvement. The present invention comprises a covering for the blind which acts as extra insulation at the window and makes cleaning of the blind easier.

### 2. Description of the Related Art.

With the invention of the venetian blind for application in domestic as well as commercial window treatments, improvement was made to window covering and decoration. In later years, coverings were invented to make cleaning and changing of the decor of the blinds easier and improve decor in homes as with U.S. Pat. Nos. 2,651,357 A and 2,590,757. The present invention seeks to make blind cleaning easier, but also increases energy savings in the home or dwelling. An added feature is a felt covering that is applied to show towards the outside of the window for decoration purposes and to increase energy savings. The appearance on the outside is that of drapery or a curtain lining.

### BRIEF SUMMARY OF THE INVENTION

The current invention introduces a heavy duty transparent plastic sleeve that comes in at least two different thicknesses fitting over a venetian blind by custom make increasing energy conservation in the home or dwelling. The outside of the winter blind covering contains two layers of heavy duty transparent plastic increasing energy savings. The sides are sown together to fit around multiple-sized venetian blinds. The top sides of the sleeve contain open holes to accommodate the blind headrail and openings for slat adjustment and lift cords. The sides and bottom contain double-sided adhesive indoor/outdoor carpet tape for adherence to the window casings or wall around the window casings to render the covering stationery. To add to the decor of the window and energy savings, a color felt covering may be added by Velcro strip or sewing to the outside of the sleeve facing the window to appear as colored drapery or curtains from the window outside.

### BRIEF DESCRIPTION OF THE SEVERAL VIEWS OF THE DRAWING

FIG. 1 consists of a standard window venetian blind.

FIG. 2 is a mock of the winter window poly/assembly through upper incision or opening and he view of the winter blind covering over the venetian blind. There are also two holes for drawstrings or lift cords to control the blind slats. Open side slots are on the upper sides of the cover for the headrails for reattachment to the box brackets.

FIG. 3 is the blind in winter window blind poly/cover through open side slots to fit blind headrails. Upper incisions are made to contain the drawstring or lift cords for controlling the blind. This is an inside view as opposed to a view from outside the house or dwelling.

FIG. 4, picture 1 is of a standard window that the winter blind/poly covered venetian blind would fit in. Picture 2 is a picture of window with the venetian blind covered by the window blind poly/cover.

FIG. 5, picture 3 shows the final assembly of the winter window blind poly/covered venetian blind to or in the window with the felt cover attachment. This is a front or outside view, that is outside of the house. Picture 4 is an isometric view of the final assembly with the felt cover attachment.

### DETAILED DESCRIPTION OF THE INVENTION

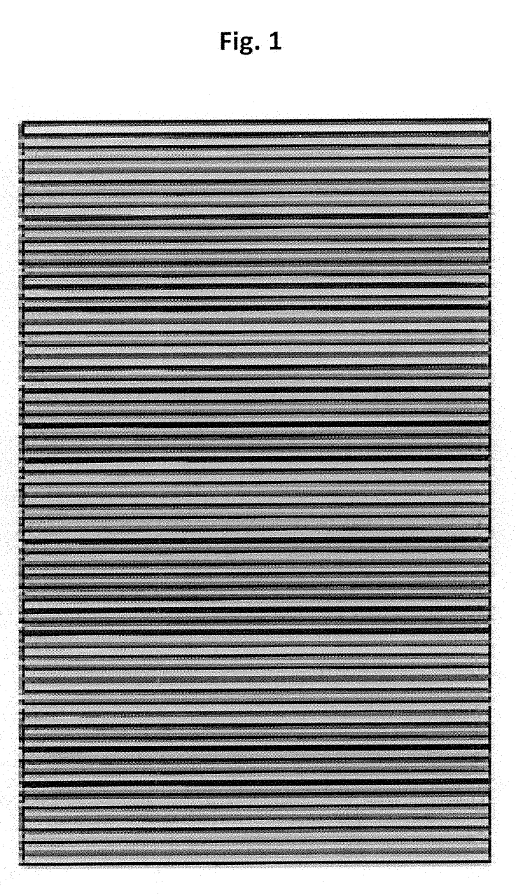

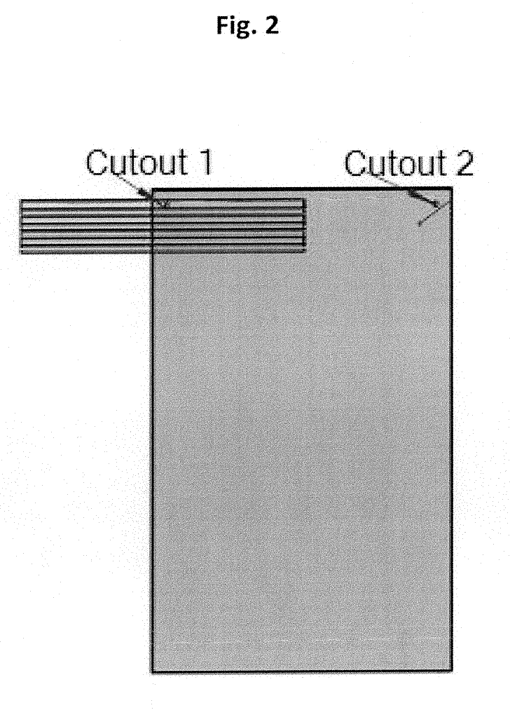

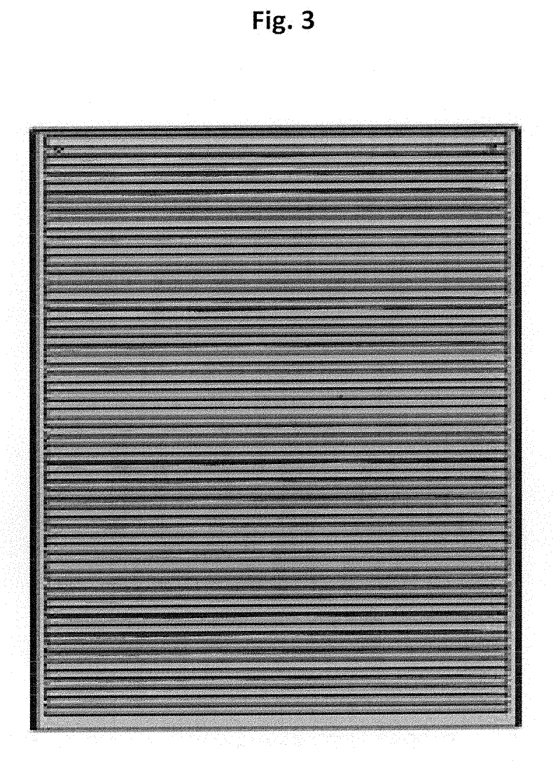

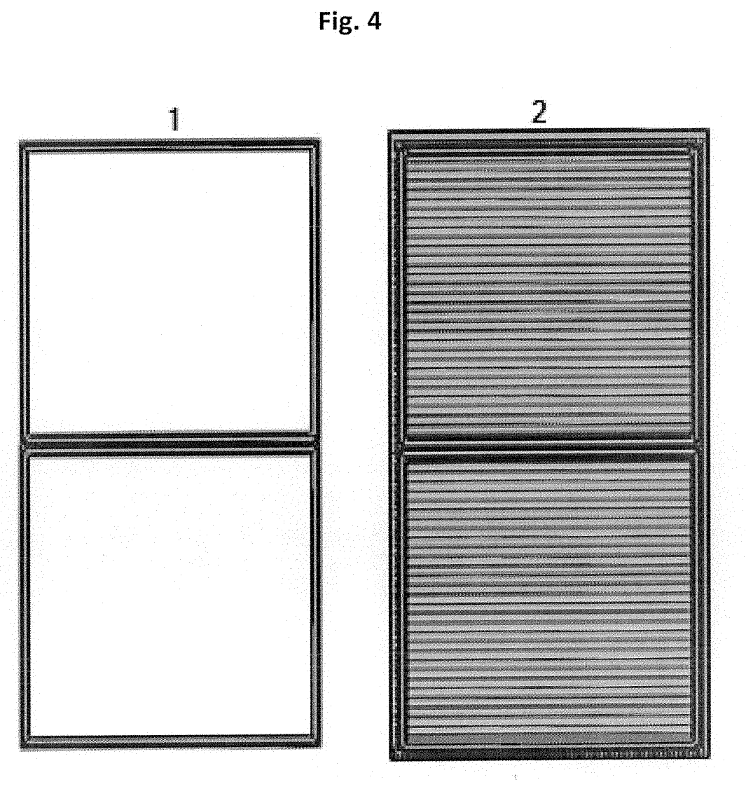

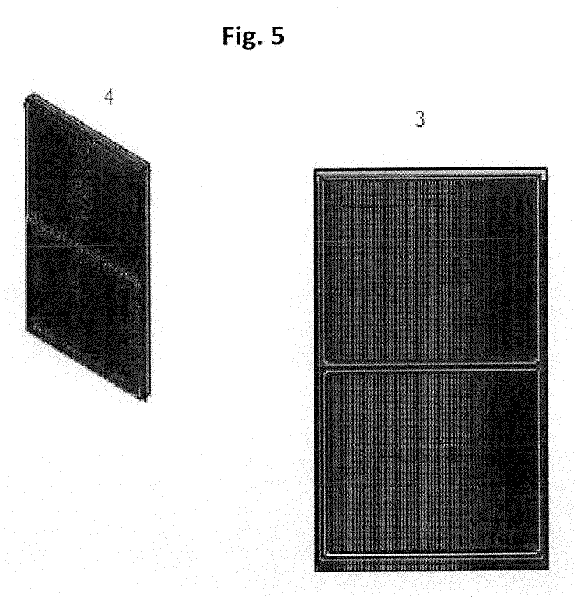

FIG. 1 shows a perspective view of a venetian blind without a cover or protection. The venetian blind alone gathers dust and dirt particles, making cleaning of the slats necessary but difficult. FIG. 2 is a mock of the clear winter blind poly (plastic sheeting) cover featuring a thickness of 6 mils or more made to fit a standard sized venetian blind improving previous venetian blind covers and increasing energy conservation with the plastic to the outside closest to the window pane featuring two layers of plastic sheeting. The winter blind covering can be custom made to fit any sized venetian blind. One sheet fits over the top of the blind or the headrail to cover the outside and inside of it sewn together on the sides except for the top half allowing the head rail to fit into the box brackets. In addition, two incisions (see Cutout 1 and Cutout 2), are made to accommodate the drawstrings or lift cords to open, close and raise the blind slats. FIG. 3 shows the inside view of the venetian blind in the winter blind covering. The covering overlaps the blind by an inch to allow easy removal of the blind and to fit inside the window to help block out hot air in the spring and summer months and cold air in the fall and winter months for energy savings. The venetian blind in the winter blind covering can then be installed in front of FIG. 4, picture 1, a standard or any other sized window. FIG. 4, picture 2 shows final assembly of the venetian blind with the winter blind covering in front of the window. Seven strips of indoor/outdoor industrial carpet tape, three on each side and one on the bottom of the blind covering, allows convenient attachment to the window sashes and sill to make the assemblage stationary and increase energy savings (not shown). This view is from the outside of the window, outside of the home or dwelling. An optional feature is FIG. 5, picture 3, a felt/lace or other material sheet of any color that is sewn or attached by Velcro strips (not shown) to the winter blind cover so that the outside of the cover has the appearance of drapery or curtains, adding to the decor of the window covering. Again, this is an outside view of the window, outside of the home.

Although the preceding description has significant detail, it should not limit the scope of the invention but provides illustrations of the intention of the invention. As an example, a client can request minor changes to the covering, such as the thickness of the plastic sheeting. This would not significantly alter the scope of the invention.

I claim:

1. A heavy poly plastic sheeting winter blind covering insulation system comprising 2 sheets, machine cut and sewn to fit a standard or any other size venetian blind configured in such a way as to conserve energy costs in the warmer and colder seasons.

2. A heavy poly plastic sheeting winter blind covering insulation system of claim 1 that is made to include 2 openings for the blind headrails and drawstrings or lift cords to raise, open or close the venetian blind slats.

3. A clear heavy poly plastic sheeting winter blind of claim 1 that is made to include double-sheeting on the side closest to the window pane that allows for adhering to the window casings and sill to hold the blind stationary and increase energy conservation, so that less hot and cold air gets into the home or dwelling.

4. A clear heavy poly plastic sheeting winter blind covering insulation system of claim 1 that allows a felt or other material sheet of any color sewn or attached by Velcro strips to the outside of it so as to increase the decor of the window from the outside view.
